(19) United States
(12) Patent Application Publication
(10) Pub. No.: US 2026/0169602 A1
(43) Pub. Date: Jun. 18, 2026

(54) SENSOR ASSEMBLY FOR DETECTING FILL LEVEL OF A RECEPTACLE

(71) Applicant: CareFusion 303, Inc., San Diego, CA (US)

(72) Inventors: Hannah Thompson, San Diego, CA (US); Serena Agrawal, San Diego, CA (US); Kristin Rominger, San Diego, CA (US); Hadley Heitzman, San Diego, CA (US); Nicole Estrich, San Diego, CA (US)

(21) Appl. No.: 19/125,262

(22) PCT Filed: Nov. 1, 2022
(86) PCT No.: PCT/US2022/048581

§ 371 Date: Apr. 28, 2025

(51) Int. Cl. G06F 3/0481

(52) U.S. Cl. CPC G06F 3/0481

(57) ABSTRACT

A sensor assembly for determining a receptacle fill level. The sensor assembly includes a bar having an adjustable feature that adjusts in response to a change in a fill level of the receptacle, one or more sensors configured to detect the adjustable feature of the bar, and a controller configured to determine, based at least on the adjustable feature of the bar, the fill level of the receptacle.

### TECHNICAL FIELD

The subject matter described herein relates generally to mechanisms of depositing items into receptacles and more specifically to a sensor assembly for detection of a fill level of a receptacle.

### BACKGROUND

Medical facilities include receptacles designed for depositing items (including medications) that might be returned to pharmacy. Items can be deposited in receptacles at varying frequencies and in different amounts, depending on a number of patients visiting the medical facilities and the medical events occurring at the medical facilities. The fluctuations in deposition of items in receptacles can completely fill the receptacles, making them unusable, before a scheduled emptying operation of the full receptacle. If a receptacle is full, health care providers, who intended to deposit items in the full receptacle, would have to search for other options to deposit the items, which might include personally storing the items (e.g., in a pocket) during the downtime of the receptacle or having to make an additional trip to the pharmacy to return medication. The urgency of depositing items in designated receptacles might be exacerbated if the items include high-value and/or controlled prescription medications, notably opioids, which would be illegal to be kept by health care providers.

### SUMMARY

Systems, sensor assemblies, and articles of manufacture, are provided for using a sensor assembly with a system for accurate detection of a receptacle fill level to optimize an emptying schedule of the receptacle.

In one aspect, a sensor assembly for determining a receptacle fill level includes a bar having an adjustable feature that adjusts in response to a change in a fill level of the receptacle, one or more sensors configured to detect the adjustable feature of the bar, and a controller configured to determine, based at least on the adjustable feature of the bar, the fill level of the receptacle.

In some implementations, a proximate edge of the bar can be secured by a pivoting joint that enables the bar to rotate in response to the change in the fill level of the receptacle. A distal edge of the bar can be configured to interact with a first sensor of the one or more sensors when the bar can be at a first adjustable feature value corresponding to the receptacle being at a first fill level, and wherein the distal edge of the bar can be further configured to interact (through contact) with a second sensor of the one or more sensors when the bar can be at a second adjustable feature value corresponding to the receptacle being at a second fill level. The controller can determine that the bar can be at the first adjustable feature value based on a first signal generated by the first sensor in response to interacting with the bar at the first adjustable feature value, and wherein the controller determines that the bar can be at the second adjustable feature value based on a second signal generated by the first sensor and the second sensor in response to interacting with the bar at the second adjustable feature value. The controller can that the bar is at a third adjustable feature value based on a third signal generated by the first sensor and the second sensor. The adjustable feature value includes a length, an angle, and/or a position of the bar relative to the one or more sensors. The controller determines that the bar can be at a first length based on a signal from the one or more sensors indicating that the bar can be at a first angle relative to the one or more sensors, and wherein the controller determines that the bar can be at a second length based on the signal from the one or more sensors indicating that the bar can be at a second angle relative to the one or more sensors. The receptacle includes a fileted edge configured to guide a distal edge of the bar through a transition between two orthogonal surfaces of the receptacle. The bar can include a telescoping bar, a spring, and/or a telescopic spring. The sensors can include a sensory array disposed along an inner surface of the receptacle. The one or more sensors can be attached to the bar. The one or more sensors can include at least one of a gyroscope, a pressure sensor, a camera, a magnetic sensor, a radio frequency sensor, and a light sensor. The controller can be further configured to generate an indicator of the fill level of the receptacle. The receptacle can be configured to receive solid materials. The receptacle can include an entry mechanism for depositing items into the receptacle. The controller can be configured to respond to the fill level of the receptacle satisfying one or more thresholds by at least blocking the entry mechanism to prevent additional items from being deposited into the receptacle. The entry mechanism includes one or more of a slot, a slanted ramp, and a door. The bar can be configured to adjust from the first adjustable feature value to the second adjustable feature value in response to one or more items being deposited in the receptacle, and wherein the bar can be further configured to reset back to the first adjustable feature value when the one or more items are removed from the receptacle. The receptacle includes a settling mechanism for optimizing an arrangement of items deposited into the receptacle. The settling mechanism includes one or more of a haptic signal and a pressure force. The controller can be physically coupled to the receptacle or can be at a remote location.

In another aspect, a depositing station includes a sensor assembly including a bar having an adjustable feature that adjusts in response to a change in a fill level of the receptacle, one or more sensors configured to detect the adjustable feature of the bar, and a controller configured to determine, based at least on the adjustable feature of the bar, the fill level of the receptacle, and one or more receptacles for depositing items.

In another aspect, a depositing system includes a depositing station including a bar having an adjustable feature that adjusts in response to a change in a fill level of the receptacle, one or more sensors configured to detect the adjustable feature of the bar, and a controller configured to determine, based at least on the adjustable feature of the bar, the fill level of the receptacle, and a depositing control system configured to control one or more actions of the depositing station based on the filling level of the one or more receptacles.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a system for detection of a receptacle fill level having a sensor assembly, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts a diagram illustrating an example of a system for detection of a receptacle fill level, in accordance with some example implementations;

FIG. 1B depicts a diagram illustrating a portion of the example of the system for detection of a receptacle fill level shown in FIG. 1A, in accordance with some example implementations;

FIGS. 2A-2D depict cross-sectional views of an example of a receptacle with sensor assembly that is progressively filling, in accordance with some example implementations;

FIGS. 3A and 3B schematically depict an example of a receptacle with sensor assembly that is progressively filling, in accordance with some example implementations;

FIG. 4 depicts a flow diagram for detecting a fill level of a receptacle, in accordance with some example implementations;

FIG. 5 depicts a block diagram illustrating an example of a computing system, in accordance with some example implementations;

When practical, similar reference numbers denote similar structures, features, or elements.

### DETAILED DESCRIPTION

Implementations of the present disclosure are generally directed to detection and monitoring of a fill level of a receptacle used for depositing items. More particularly, implementations of the present disclosure are directed to a sensor assembly for a receptacle that includes an adjustable bar, sensors, and a controller. The bar can be attached internally within the receptacle to track the fullness level as items are added. The bar has an adjustable feature (such as a position, angle, and/or length) that adjusts in response to a change in a fill level of the receptacle. The sensors can interact with (or can be incorporated within) the bar to detect a value of the adjustable feature (the length and/or position) of the bar. The controller receives signals from the sensors that indicate the value of the adjustable feature (length and/or position) of the bar to derive the fill level of the receptacle based on the value of the adjustable feature (length and/or position) of the bar. The controller can be coupled to with an indicator (e.g., LED lights, software) to relay the fullness level to receptacle users.

Automatic detection and real-time tracking of fill levels of receptacles (without human intervention) can help with optimizing an emptying schedule of the receptacles to avoid allowing the receptacle to become completely full and therefore unusable. By maintaining the fill level of receptacles within usable ranges, the system prevents delays with item deposition, preventing such delays to interfere with a schedule of a receptacle user. Another advantage of the receptacle sensor assembly is that the bar is configured to automatically adjust its value of the adjustable feature (length, angle, and/or or position) in response to the receptacle being emptied, triggering a reset of a fill level of the receptacle to indicate that the receptacle is empty. A geometry of the receptacle can also be adapted to include a curved transition from a horizontal surface to a vertical surface, to optimize a movement of the bar within the receptacle, preventing the bar from getting stuck within the transition from the horizontal surface to the vertical surface. Accordingly, the sensor assembly described herein may enable an accurate automatic detection and real-time monitoring of fill levels of receptacles.

Implementations of the present disclosure will be described in view of an example context. The example context includes automatic detection and real-time monitoring of fill levels of receptacles located within medical facilities. Within the example context the receptacles can be used, by receptacle users, for depositing (or dispensing of) medical items, including medication that would need to be returned to a pharmacy within a set time interval. The fill level monitoring system can enable receptacle users to deposit items in available receptacles with a fill level below a set threshold. In the context of a medication management system, only assigned receptacle users (‘receptacle controllers’) are permitted to access the contents in the return receptacle and re-process medications that have been returned. The fill level monitoring system can process receptacle data collected by the sensor assembly to prompt receptacle controllers to empty the receptacle at appropriate intervals. Adjustment of emptying schedule based on receptacle fill levels can prevent the receptacles within a medical facility from becoming full and therefore unusable for the health care providers, who need to return medications to a particular receptacle.

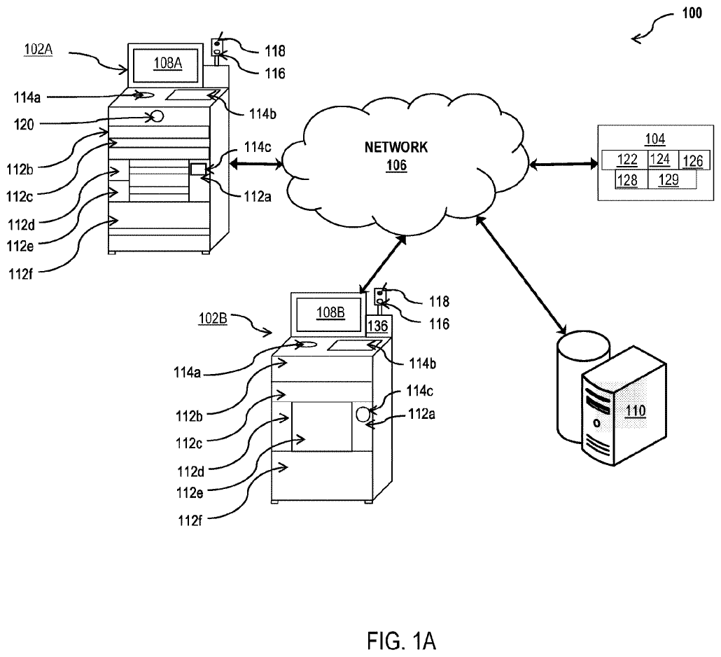

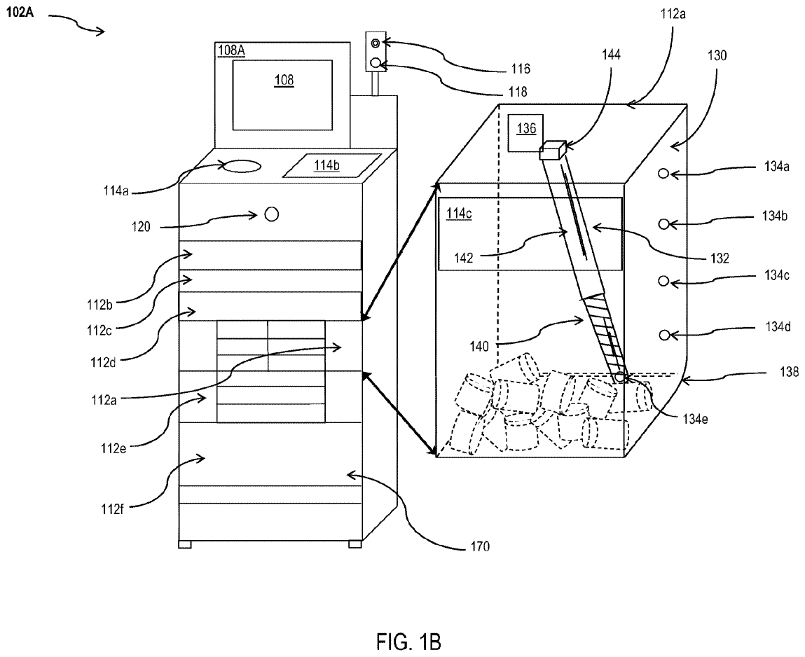

Implementations of the present disclosure are described in further detail herein within an example context of example forms of medical systems. More specifically, and with reference to FIG. 1A, a simplified example of a system for detection and real-time tracking of fill levels of receptacles within a medical facility is provided. In view of this context, the present disclosure provides integrated visibility of detected fill levels of receptacles to enable real-time adjustment of receptacle emptying schedule. It is appreciated, however, that implementations of the present disclosure are readily applicable in other contexts with other forms of automatic detection and real-time tracking of fill levels of receptacles.

FIG. 1A depicts a diagram illustrating an example system architecture 100 for detection of a receptacle fill level, in accordance with some example implementations. The example system architecture 100 includes a first depositing system 102A, a second depositing system 102B, a user device 104, a network 106, and a data processing system 110. As discussed in further detail herein, each depositing system 102A, 102B includes a user device 108A, 108B configured to determine, display, and transmit receptacle fill level data associated with the receptacles 112a-112f of each of the first and second depositing systems 102A, 102B. For example, the user devices 108A, 108B can transmit receptacle fill level data, over the network 106 to the data processing system 110 for processing and to the user device 104 or any other user device and for presentation or display. Although a single user device 104 is illustrated, it is contemplated that one or more user devices 104 can communicate with each of the first and second depositing systems 102A, 102B through the network 106. Further, data can be transferred between the data processing system 110 and each of the first and second depositing systems 102A, 102B through the network 106. Although two depositing systems 102A, 102B are illustrated, implementations of the present disclosure can include more depositing systems. Some instances of the depositing system 102A, 102B may be configured as automated medication dispensing cabinets including features similar to, for example, a BD Pyxis MedStation™ from Becton, Dickinson and Company.

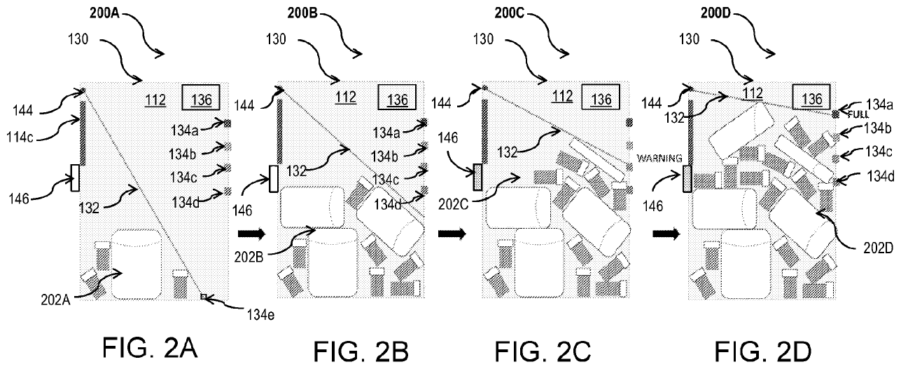

Each depositing system 102A, 102B can be provided as an item depositing system that enables tracking of receptacle fill levels, and the like. The depositing systems 102A, 102B can include one or more receptacles 112a-112f that are being monitored to track the fill level of each individual receptacle 112a-112f, using a sensor assembly as described with reference to FIGS. 1B, 2A-D, 3A, and 3B. In the example system architecture 100 of FIG. 1A, the first depositing system 102A, and the second depositing system 102B include a plurality of receptacles 112a that could each be configured to securely receive items, when the fill level is below a set threshold (receptacle is not full) and to store the deposited items until the receptacle 112a-112f is emptied by assigned users (receptacle controllers). It is contemplated that each depositing system 102A, 102B can include one or more receptacles 112a-112f, of different shapes and sizes, without being limited to the example arrangement illustrated in FIGS. 1A and 1B. The receptacles 112 a-112f can include drawers and/or bins. Each of the receptacles 112 a-112f can include a sensor assembly configured to monitor a fill level of the respective receptacle 112a-112f, as described with detail to FIGS. 1B, 2A-2C, 3A, and 3B.

Each depositing system 102A, 102B includes a user (computing) device 108A, 108B to guide a user through the depositing process, including, for example, authenticating the user, labeling and/or securing the deposited item, and/or depositing the item in a corresponding receptacle through a deposit point (e.g., a first item type general receiver 114a or a second item type general receiver 114b or an entry mechanisms 114c of a respective receptacle 112a) of the depositing system 102A, 102B. Also shown in the representation of the depositing system 102A, 102B of FIGS. 1A and 1B are a biometrics scanner 116, a camera 118, and a smart lock 120. The user device 108A, 108B integrated in the depositing system 102A, 102B includes a user interface 108 that may display prompts on the display and/or accept inputs from the user to guide the user through the depositing process, thereby confirming each step is complete, secure, and auditable. The user device 108A, 108B integrated in the depositing system 102A, 102B may provide visual feedback based on images captured by the camera 118. The visual feedback may allow the user to verify that the depositing system 102A, 102B has a clear image of the item being deposited in selected receptacles 112a-112f that are detected as not being full.

The receptacles 112a-112f may include one or more drawers. The receptacles 112a-112f may include audit receptacles, for example, receptacles of highly controlled substances. The receptacles 112a-112f may each include passages to an interior of the receptacle in a way that optimizes detection of fill level of receptacle (e.g., from a direction that would generate a trigger of a sensor detecting a change in fill level). The receptacles 112a-112f can be configured for depositing items in bulk. The arrangement, as shown in FIGS. 1A and 1B, allows for the collection of different types of items in receptacles 112 a-112f for auditing the deposited items. Moreover, the drawer arrangement as shown in FIGS. 1A and 1B allows for the items not selected for audit to be collected in the bulk receptacles. In some implementations, the depositing systems 102A, 102B are located at the same facility or at different facilities. In the case of multiple facilities, the facilities can be remotely located from one another, and/or can be located at a common location, or site (e.g., separate departments in a common (the same) building).

In some implementations, each facility includes an associated data processing system 110. Each data processing system 110 can be provided as a server (e.g., a front-end server, a back-end server, a cloud server), and supports the acquisition, storage, modification, and distribution of receptacle fill level information, such as receptacle fill levels, throughout the facility including the depositing systems 102A, 102B. Although the example system architecture 100 includes a data processing system 110 located remotely from the depositing systems 102A, 102B, it is contemplated that the data processing system 110 can be integrated within the depositing systems 102A, 102B.

In some implementations, the user device 104, 108A, 108B can include a personal computer (PC) (e.g., desktop, laptop, or tablet). Communication between each user devices 104, 108A, 108B and the data processing system 110 can be achieved via a direct connection, or remotely through the network 106 that can include, but is not limited to, a local area network (LAN), a wide area network (WAN), and/or the Internet.

The user device 104 can include any number of example devices. Such example devices include, but are not limited to, a mobile phone, a smartphone, a tablet computing device, a personal digital assistant (PDA), a laptop personal computer (PC), a desktop PC, and/or appropriate combinations thereof. In the depicted example, the user device 104 includes a display 122, a processor 124, memory 126, an input interface 128, and a communication interface 129. The processor 124 can process instructions for execution of implementations of the present disclosure. The instructions can include, but are not limited to, instructions stored in the memory 126 to display graphical information on the display 122. Example displays include, but are not limited to, a thin-film-transistor (TFT) liquid crystal display (LCD), or an organic light emitting diode (OLED) display. The memory 126 stores information within the user device 104. In some implementations, the memory 126 can include a volatile memory unit or units, and/or a non-volatile memory unit or units. In other implementations, removable memory can be provided, and can include, but is not limited to, a memory card. Example memory cards can include, but are not limited to, a secure digital (SD) memory card, a mini-Secure Digital (SD) memory card, a Universal Serial Bus (USB) stick, and the like.

In some implementations, the input user interface 108, 128 can include a keyboard, a touchscreen, a mouse, a trackball, a microphone, a touchpad, and/or appropriate combinations thereof. In some implementations, an audio codec (not shown) can be provided, which receives audible input from a user or other source through a microphone, and converts the audible input to usable digital information. The audio codec can generate audible sound, such as through a speaker that is provided with the user device 104. Example sounds can include sound from voice telephone calls, recorded sound (e.g., voice messages, music files, etc.), and/or sound generated by applications operating on the user device 104.

The user devices 104, 108A, 108B can communicate over the network 106 through a connectivity interface(s). In some implementations, the connectivity interface(s) can include a satellite receiver, cellular network, a Bluetooth system, a Wi-Fi system (e.g., 802.x), a cable modem, a DSL/dial-up interface, a private branch exchange (PBX) system, and/or appropriate combinations thereof. Each of these connectivity interfaces enables data to be transmitted to/from the network 106. In some implementations, the network 106 can be provided as a local area network (LAN), a wide area network (WAN), a wireless LAN (WLAN), a metropolitan area network (MAN), a personal area network (PAN), the Internet, and/or combinations thereof.

In some implementations, each depositing system 102A, 102B includes a sensor assembly 130 to monitor a receptacle fill level of each receptacles 112a-112f, and generates data signals based thereon. As discussed in further detail herein with reference to FIG. 1B, implementations of the present disclosure provide a sensor assembly 130 that includes a bar 132, one or more sensors 134a-e, and a controller 136.

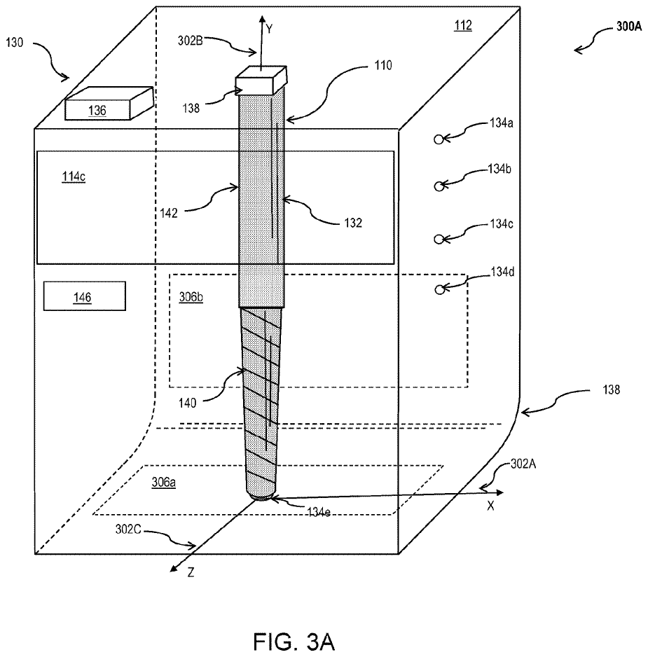

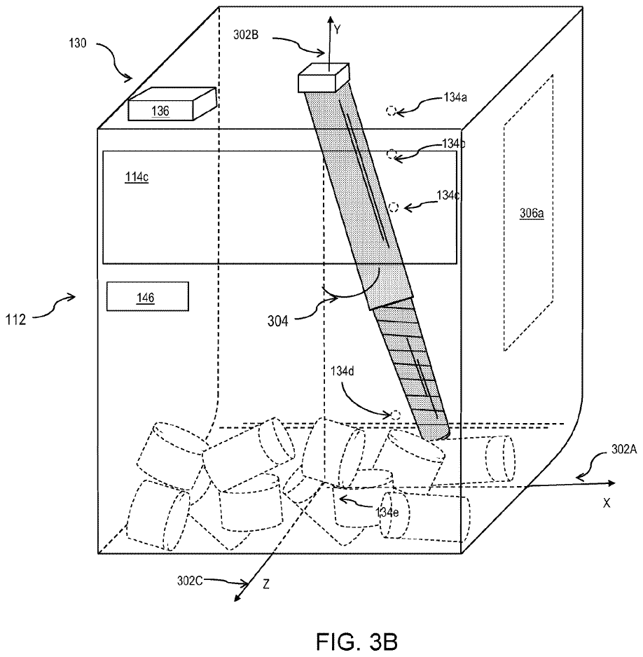

The bar 132 has an adjustable feature (a length, angle, and/or position) that adjusts in response to a change in a fill level of the receptacle 112a. The bar 132 can be made of an inelastic light weight material (e.g., fiberglass, plastic or plexiglass), from metal (e.g., stainless steel), or any other types of materials that do not break neither bend when coming in contact with deposited items. The bar 132 can be secured to an interior wall of the receptacle 112a by a pivoting joint 144 that enables the bar to rotate (without bending) in response to the change in the fill level of the receptacle 112a (as shown in FIGS. 2 and 3). The bar 132 can include a variable length section 140 and, optionally, a fixed length section 142. The variable length section 140 can become shorter as the receptacle fill level increases and can be configured to automatically extend to maximum length after the receptacle is emptied. The variable length section 140 of the bar 132 can include a telescoping bar, a spring, and/or a telescopic spring.

The sensors 134a-e can include a sensory array 134a-134d disposed along an inner surface of the receptacle 112f and, additionally or alternatively, one or more sensors 134e attached to the bar 132 (e.g., an ending portion of the bar 132) or the pivoting joint 144. The sensory array 134a-134d can include multiple sensors in the array. The number of sensors in the sensory array 134a-134d can vary to give a selected granularity of receptacle fill level detection. The sensors 134a-e can include a gyroscope, a pressure sensor, a camera, a magnetic sensor, a radio frequency sensor, a light sensor, a force sensor, a pressure sensor, or the like. For example, the sensors 134a-e can detect a location of one or more points of the bar 132 (e.g., a distal end of the bar 132) or the location of the entire bar.

The sensors 134a-e can detect the signals associated with filling level of a respective receptacle 112 a continuously and/or at various time intervals (e.g., every 10 seconds, 30 seconds, 1 minute, 30 minutes, 1 hour, 12 hours, 24 hours, and the like). In some implementations, the controller 136 controls the time at which the sensors 134a-e measure the bar length and angle. The sensors 134a-e may transmit signals of the detected bar length, position and/or angle to the controller 136 immediately after the signal detection. In some implementations, the sensors 134a-e can be activated by an activation of an entry mechanism 114c to detect a change in bar length based on a change in receptacle fill level (after deposition of items within the receptacle 112a through the entry mechanism 114c). The entry mechanism 114c can include a slot, a slanted ramp, and a door. The entry mechanism 114c can be generally blocked to prevent access to the corresponding receptacle 112a and can be opened in response to a user's request to deposit items and in response to the sensor assembly indicating that a fill level of the receptacle 112a is below a critical fill level (e.g., receptacle 112a is not full). For example, the controller 136 can be configured to respond to the fill level of the receptacle 112a satisfying one or more thresholds by at least blocking the entry mechanism 114c to prevent additional items from being deposited into the receptacle 112a.

The sensors 134a-e can be configured to generate signals indicative of a receptacle fill level (length or position of the bar 132) and transmit them to the controller 136. The controller 136 can process signals received from the sensors 134a-e to determine, based at least on the length of the bar 132 and, optionally or alternatively, based on the angle or position of the bar 132, the fill level of the receptacle 112a. The controller 136 can be configured to transmit the fill level of the receptacle to the user interface 108 and/or an indicator 146 to display the fill level of the receptacle 112a. For example, the controller can be coupled to with the indicator 146 (e.g., LED lights, software) to relay the fullness level of the receptacle 112a to potential receptacle users. In some implementations, the indicator 146 can use a color code to indicate the fullness level of the receptacle 112a (e.g., green color indicating that the receptacle includes sufficient empty volume for depositing additional items, orange color indicating that the receptacle includes limited empty volume for depositing additional items, and red color indicating that the receptacle is full and includes insufficient empty volume for depositing additional items).

The controller 136 can be physically coupled to the receptacle 112a or it can be positioned at a location separate from the receptacle 112a. In some implementations, a distal edge of the bar 132 is configured to interact (through contact) with a first sensor (e.g., sensor 134d) of the one or more sensors 134a-e when the bar 132 is at a first length corresponding to the receptacle being at a first fill level. The controller 136 can determine that the bar 132 is at the first length based on a first signal generated by the first sensor 134d in response to interacting with the bar 132 at the first length. The distal edge of the bar 132 can be further configured to interact with a second sensor (e.g., sensor 134a, 134b, or 134c) of the one or more sensors when the bar is at a second length corresponding to the receptacle being at a second fill level (e.g., the receptacle 112a being more filled with items than at the first fill level). The controller 136 can determine that the bar 132 is at the second length based on a second signal generated by the first sensor and the second sensor in response to interacting with the bar at the second length. The controller 136 can determine that the bar 132 is at a third length, greater than the first length and shorter than the second length based on a third signal generated by the first sensor 134d and the second sensor (e.g., sensor 134a, 134b, or 134c).

In some implementations, at least a portion of the inner walls of the receptacle 112a can be configured to enable a movement of the bar 132 within the receptacle 112a. For example, a portion of the inner walls of the receptacle 112a can include a fileted edge 138 configured to guide a distal edge of the bar 132 through a transition between two orthogonal surfaces of the receptacle 112a. The fileted edge 138 can include a curved surface with a radius that matches the variable length of the bar 132 as it transitions between two orthogonal (horizontal and vertical) surfaces of the receptacle 112a. The fileted edge 138 can be oppositely located from the entry mechanism 114c, such that the bar 132, when pushed by the deposited items towards the fileted edge 138 and away from the entry mechanism 114c, can rotate and adjust the length to indicate the fill level of the receptacle 112a.

FIGS. 2A-2D schematically depict vertical cross-sectional views 200A, 200B, 200C, 200D of an example sensor assembly 130 used to monitor a filling level of a receptacle 112, consistent with implementations of the current subject matter. The vertical cross-sectional views 200A, 200B, 200C, 200D of the example sensor assembly 130 indicate examples of length and angle variation of the bar 132 as the receptacle is filled with a first amount of items 202A, a second amount of items 202B, a third amount of items 202C, and a fourth amount of items 202D. In the illustrated examples of the vertical cross-sectional views 200A, 200B, 200C, 200D of the example sensor assembly 130, the variable length bar 132 has a length that decreases with an increasing amount of items 202A, 202B, 202C, 202D deposited in the receptacle 112. The bar 132 can attached to a top portion of the receptacle 112, for example, as illustrated in FIGS. 2A-2D, above the entry mechanism 114c. In the illustrated examples of the vertical cross-sectional views 200A, 200B, 200C, 200D of the example sensor assembly 130, the bar 132 forms an angle with a vertical axis (e.g., a vertical wall of the receptacle 112) that increases with an increasing amount of items 202A, 202B, 202C, 202D deposited in the receptacle 112. The example sensor assembly 130 can be coupled to an indicator 146 that can indicate the fullness level of the receptacle 112. The indicator 146 can be attached to an exterior surface of the receptacle 112 to enable visualization of the fill level indication. For example, the indicator 146 can be attached to the exterior surface of the receptacle 112 near to the entry mechanism 114c that is used for depositing items. In some implementations, the indicator 146 can use a color code to indicate the fullness level of the receptacle 112a (e.g., green, orange, and red) or a numerical display indicating the available or used volume of the receptacle as a percentage or a fillable bar icon that matches the available or used volume of the receptacle.

FIGS. 2A and 2B illustrate examples of vertical cross-sectional views 200A, 200B with different receptacle fill levels that provide sufficient empty volume within the receptacle 112 to enable deposition of additional items. For the examples illustrated in FIGS. 2A and 2B, one or more of the sensors 134a-d detect that the bar 132 has a particular length that is greater than a threshold length and/or the bar 132 is at a particular angle that is smaller than an angle threshold, which the controller 136 can use to indicate that the receptacle 112 includes sufficient empty volume for depositing additional items. In some implementations, a signal generated by an interaction between a distal portion (end) of the bar and the sensors can indicate a receptacle fill level. For example, as shown in FIGS. 2A and 2B, if the distal portion (end) of the bar does not interact with the sensors, the sensors can indicate that the receptacle fill level is below a set threshold and the receptacle is available to store additional items. The indicator 146 can use a first color (e.g., green) indicating that the receptacle includes sufficient empty volume for depositing additional items.

FIG. 2C illustrates an example of vertical cross-sectional views 200C with a critical receptacle fill level (being almost full) that provides limited empty volume within the receptacle 112 to enable deposition of additional items. In some implementations, if one or more of the sensors 134a-d detect that the bar 132 has a particular length that is equal or smaller than a threshold length and/or the bar 132 is at a particular angle that is equal or greater than an angle threshold (e.g., as illustrated in FIG. 2C), an alert can be generated by the controller 136 to indicate that the receptacle 112 reached a critical fill level and the receptacle 112 should be planned to be emptied within a particular period of time. As shown in FIG. 2C, if the distal portion (end) of the bar interacts with a sensor 134c, the sensor 134c can indicate that the receptacle fill level is at a corresponding fill level and the receptacle might be available to store additional (critical) items. The indicator 146 can use a second color (e.g., orange) indicating that the receptacle includes limited empty volume for depositing additional items.

FIG. 2D illustrates an example of vertical cross-sectional views 200D with a maximum receptacle fill level (being completely full) that provides insufficient empty volume within the receptacle 112 to enable deposition of additional items. In some implementations, if one or more of the sensors 134a-d detect that the bar 132 has a particular length that is equal or smaller than a second threshold length and/or the bar 132 is at a particular angle that is equal or greater than a second angle threshold (e.g., as illustrated in FIG. 2D), an alert can be generated by the controller 136 to indicate that the receptacle 112 reached a maximum fill level (being full and unusable) and the receptacle 112 should be prioritized to be emptied within a particular period of time. As shown in FIG. 2D, if the distal portion (end) of the bar interacts with a particular sensor 134a, the sensor 134a can indicate that the receptacle fill level is at a maximum fill level and the receptacle might not be available to store any additional items. The indicator 146 can use third color (e.g., red) indicating that the receptacle is full and includes insufficient empty volume for depositing additional items.

FIGS. 3A and 3B schematically depict three dimensional views 300A, 300B, of an example sensor assembly 130 used to monitor a filling level of a receptacle 112, consistent with implementations of the current subject matter. In FIGS. 3A and 3B the three dimensional views 300A, 300B illustrate the example sensor assembly 130 relative to a Cartesian system of coordinates including direction X 302A, direction Y 302B, and direction Z 302C.

As previously described, the example sensor assembly 130 includes a bar 132, one or more sensors 134a-e, and a controller 136. The bar 132 has a length that adjusts in response to a change in a fill level of the receptacle 112, FIG. 3A illustrating an example of an empty receptacle 112 and FIG. 3B illustrating an example of a partly filled receptacle 112 having sufficient empty volume to deposit additional items. The bar 132 can be secured to an interior wall of the receptacle 112 by a pivoting joint 144 that enables the bar to rotate, for example within a vertical (YZ) plane that is orthogonal to a (XY) vertical plane including the entry mechanism 114c. The bar 132 can rotate in response to the change in the fill level of the receptacle 112. For example, the bar 132 can be in a vertical position (parallel to direction Y 302B) when the receptacle is empty (as shown in FIG. 3A) and the bar can be inclined when the receptacle is partly filled (as shown in FIG. 3B). The bar 132 can include a variable length section 140 and, optionally, a fixed length section 142. The variable length section 140 can be at a maximum length when the receptacle is empty (as shown in FIG. 3A) and can have shorter length when the receptacle is partly filled (as shown in FIG. 3B), having a minimum length when the receptacle 112 is completely full. In some implementations, the width of the bar (along the X direction) can vary with the width of the receptacle (can be larger than depicted) to minimize a possibility of the receptacle contents to fall around or behind the bar.

In some implementations, at least a portion of the inner walls of the receptacle 112a can be configured to enable a movement of the bar 132 within the receptacle 112a. For example, a portion of the inner vertical rear wall of the receptacle 112a can include a fileted edge 138 configured to guide a distal edge of the bar 132 through a transition between two orthogonal surfaces of the receptacle 112a (within the ZY plane). The fileted edge 138 can include a curved surface (within the ZY plane) with a radius that matches the variable length of the bar 132 as it transitions between two orthogonal (horizontal and vertical) surfaces of the receptacle 112a. The fileted edge 138 can be oppositely located from the entry mechanism 114c, such that the bar 132, when pushed by the deposited items towards the fileted edge 138 and away from the entry mechanism 114c, can rotate in the YZ plane and adjust the length to indicate the fill level of the receptacle 112a.

As illustrated in FIGS. 3A and 3B, the sensors 134a-e can include a sensory array 134a-134d disposed along an inner (side or rear vertical) surface of the receptacle 112 and one or more sensors 134e attached to the bar 132 (e.g., an ending portion of the bar 132). The sensory array 134a-134d can include multiple sensors in the array that could be positioned along a vertical line (parallel to direction Y 302B). The sensory array 134a-134d can include multiple sensors in the array that could be equidistantly positioned or could have varying distances between them (e.g., having shorter distances between sensors that detect filling levels closer to the maximum filling level) to give a selected granularity of receptacle fill level detection. The sensors 134a-e can detect a location of one reference point of the bar 132 (e.g., a distal end of the bar 132) or the location of multiple reference points distributed along the bar 132 (including the distal end of the bar 132). In some implementations, the bar 132 includes markers that increase the detection accuracy of the sensors 134a-e. The sensors 134a-e can be configured to generate signals indicative of the one or more reference points of the bar 132 using the Cartesian system of coordinates including direction X 302A, direction Y 302B, and direction Z 302C and optionally, relative to a receptacle reference point (e.g., pivoting joint 144). In some implementations, one or more sensors may be included within the fixed section 142 of the bar 132 to measure a position of the variable length portion 140.

The sensors 134a-e can be configured to generate signals indicative of a length of the bar 132. One or more sensors 134 a-e can be configured to detect an angle 304 of the bar 132 relative to the one or more sensors 134 a-e and to transmit the detected angle 304 to the controller 136. The one or more sensors 134a-e can be configured to transmit the detected signal to the controller 136. The controller 136 can process signals received from the sensors 134a-e to determine, based at least on the length of the bar 132 and, optionally, based on the angle 304 of the bar 132, the fill level of the receptacle 112. The controller 136 can be configured to transmit the fill level of the receptacle to the user interface 108 and/or an indicator 146 to display the fill level of the receptacle 112. For example, the controller 136 can be coupled to with the indicator 146 (e.g., LED lights, software) to relay the fullness level of the receptacle 112 to potential receptacle users.

The controller 136 can be physically coupled to the receptacle 112 or it can be positioned at a location separate from the receptacle 112. In some implementations, the controller 136 can activate an item settling feature 306a, 306b in response to determining that the entry mechanism 114c was activated. The item settling feature 306a, 306b can be configured to generate a movement impulse (e.g., vibration, rotation, vertical oscillation) to trigger settling of items deposited within the receptacle 112. The item settling feature 306a, 306b can be attached to any vertical and/or horizontal wall of the receptacle 112. In some implementations, the controller 136 can activate the sensors 134a-e to detect the length of the bar 132 and, optionally, based on the angle 304 of the bar 132, after the items within the receptacle 112 are settled. The controller 136 may translate or convert the sensor measurements to determine the length and angle of the bar and corresponding filling levels of the receptacle 112. In some implementations, the controller 136 can detect that filling level of the receptacle 112 exceeds a critical level. For example, the controller 136 may compare a detected filling level of the receptacle 112 to a threshold level (e.g., greater than a set percentage of a total height of the receptacle 112). The controller 136 can transmit a signal to the indicator 146 to display an indication of the detected filling level of the receptacle 112 relative to one or more threshold filling levels.

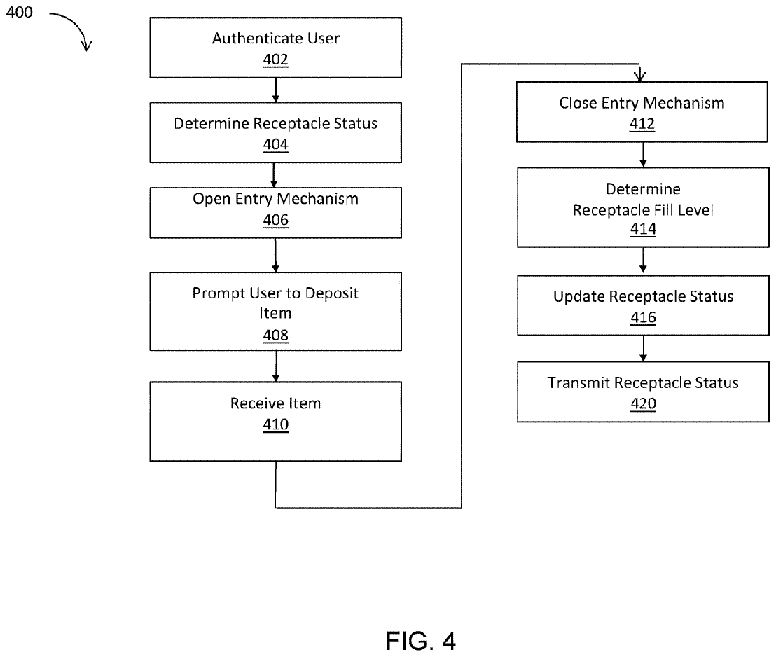

FIG. 4 depicts a flowchart illustrating a process 400 for determining a fill level of a receptacle, consistent with implementations of the current subject matter. The process 400 may be implemented by one or more of the specifically configured devices described with reference to FIGS. 1-3.

At 402, a depositing system, such as depositing systems 102A, 102B described with reference to FIGS. 1A and 1B, authenticates a user. In some implementations, user authentication includes processing a user input including a user name and password, scanning a user identification card using the camera or the sensor, scanning a biometric feature of the user using the camera or the sensor or any combination thereof. In some implementations, the user input includes a request to deposit one or more items in a receptacle.

At 404, a current receptacle status is determined by a controller, such as the controller 136, described with reference to FIGS. 1-3. In some implementations, determining the current receptacle status includes identifying a receptacle configured to deposit the items identified for depositing. Identifying a receptacle configured to deposit the identified items can include matching a receptacle type to an item type. The current receptacle status can include an availability of the receptacle to store additional items based on a current fill level of the receptacle. In some implementations, determining the availability of the receptacle to store additional items includes comparing the current fill level of the receptacle to a fill level threshold. For example, if the current fill level of the receptacle is below a set threshold (e.g., 90% of total fill level of the receptacle), the receptacle is identified as being available for depositing additional items.

At 406, if the receptacle is identified as being available for depositing additional items, an entry mechanism is opened to enable the user to deposit the items in the receptacle. The entry mechanism, such as the entry mechanism 114c, described with reference to FIGS. 1-3, can enable deposition of items in the receptacle in a manner that triggers a movement of a variable length bar that is monitored to derive the change in the fill level of the receptacle. At 408, a user is prompted to deposit the item(s). For example, a user interface of the depositing system, such as user interface 108 described with reference to FIG. 1B, can generate a visual and/or audio command for the user to deposit the item(s).

At 410, a sensor can detect that the items have been deposited in the receptacle. For example, a sensor assembly, such as the sensor assembly 130, described with reference to FIGS. 1-3, can detect that the items have been deposited in the receptacle. The sensor assembly can be configured to detect, by one or more sensors, a length change of a variable length bar, indicative of the items being deposited. The sensors may transmit a signal indicative of the items being deposited in the receptacle, to a controller coupled to the sensor, such as controller 136, described with reference to FIGS. 1-3. In some implementations, in response to receiving the signal indicative of the items being deposited in the receptacle, the controller can activate a settling feature of the receptacle to optimize an arrangement of the items within the receptacle, by minimizing a volume occupied by the items within the receptacle. At 412, the controller can transmit a signal for the entry mechanism to be closed to prevent unmonitored handling of items deposited in the receptacle.

At 414, the controller can determine, based on the length of the variable length bar and, optionally, based on the angle or position of the bar, as detected by the sensors, an updated fill level of the receptacle (after the items were deposited). For example, the measured length of the variable length bar and angle of the bar can each have a set mathematical relationship (that can be defined in a lookup table) with the remaining available volume in the receptacle for depositing additional items. Each of the measured length of the variable length bar and angle of the bar can be separately used to estimate the fill level. An average of the two fill level estimates can be used (if a difference between the two estimates is not greater than a set threshold) to determine the current fill level with an increased accuracy of the fill level estimate. In some implementations, the updated fill level of the receptacle can be used as an input for a machine learning algorithm to estimate a future expected fill level of the receptacle within a set period of time (e.g., next 6 hours, 12 hours, 24 hours, 2 days, 3 days, and/or 7 days).

At 416, a receptacle status is updated based on the current fill level and the receptacle status is transmitted to an indicator, such as indicator 146, described with reference to FIGS. 1-3, to illustrate a fill status of the receptacle. In some implementations, the indicator indicates the fill status of the receptacle using a color code that can be visible for a user of the depositing system. In some implementations, the controller transmits an alert based on the updated fill status of the receptacle, such as to a display of the depositing system (e.g., the input user interface 108). The alert may include a visual, audio, audiovisual, tactile, and/or the like, indicator that indicates the fill status of the receptacle.

At 418, the fill status of the receptacle can be transmitted to a central computing system, such as data processing system 110, described with reference to FIG. 1A, to enable management of receptacle emptying plan for the receptacle and one or more receptacles of a facility.

The system for detection of a receptacle fill level including the sensor assembly described herein may accurately determine the receptacle fill level based on length detection of a variable length bar, which helps to improve control of deposition of items within receptacles and a receptacle emptying plan to prevent allowing receptacles to be filled until they cannot be used for deposition of additional items.

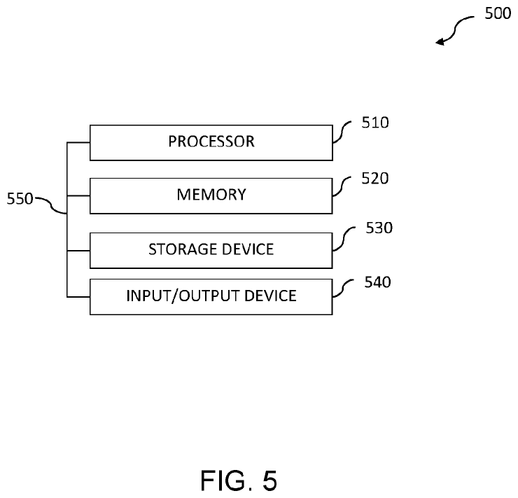

FIG. 5 depicts a block diagram illustrating a computing system 500 consistent with implementations of the current subject matter. Referring to FIGS. 1 and 5, the computing system 500 can be specifically configured for determining a fill level of a receptacle of a depositing system with a computing system, a display, and/or any components therein.

As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The processor 510 is capable of processing instructions for execution within the computing system 500. Such executed instructions can be implemented by one or more components of, for example, the depositing system 102A, 102B. In some example implementations, the processor 510 can be a single-threaded processor. Alternatively, the processor 510 can be a multi-threaded processor. The processor 510 is capable of processing instructions stored in the memory 520 and/or on the storage device 530 to present graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some example implementations, the input/output device 540 includes a keyboard and/or pointing device. In various implementations, the input/output device 540 includes a display unit for displaying graphical user interfaces.

According to some example implementations, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some example implementations, the computing system 500 can be used to execute various interactive computer software applications that can be used for organization, analysis and/or storage of data in various formats. Alternatively, the computing system 500 can be specifically configured to execute software applications. These applications can perform various fullness detection functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in specifically configured digital electronic circuitry, integrated circuitry, application-specific integrated circuit (ASIC), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C,” “one or more of A, B, and C,” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

As used herein a “user interface” (also referred to as an interactive user interface, a graphical user interface or a user interface or UI) may refer to a network based interface including data fields and/or other control elements for receiving input signals or providing electronic information and/or for providing information to the user in response to any received input signals. Control elements may include dials, buttons, icons, selectable areas, or other perceivable indicia presented via the UI that, when interacted with (e.g., clicked, touched, selected, etc.), initiates an exchange of data for the device presenting the UI. A UI may be implemented in whole or in part using technologies such as hyper-text mark-up language (HTML), FLASH™, JAVA™, NET™, web services, or rich site summary (RSS). In some implementations, a UI may be included in a stand-alone client (for example, thick client, fat client) configured to communicate (e.g., send or receive data) in accordance with one or more of the aspects described. The communication may be to or from a medical device or server in communication therewith.

As used herein, the terms “determine” or “determining” encompass a wide variety of actions. For example, “determining” may include calculating, computing, processing, deriving, generating, obtaining, looking up (e.g., looking up in a table, a database or another data structure), ascertaining and the like via a hardware element without user intervention. Also, “determining” may include receiving (e.g., receiving information), accessing (e.g., accessing data in a memory) and the like via a hardware element without user intervention. “Determining” may include resolving, selecting, choosing, establishing, and the like via a hardware element without user intervention.

As used herein, the terms “provide” or “providing” encompass a wide variety of actions. For example, “providing” may include storing a value in a location of a storage device for subsequent retrieval, transmitting a value directly to the receptacle via at least one wired or wireless communication medium, transmitting or storing a reference to a value, and the like. “Providing” may also include encoding, decoding, encrypting, decrypting, validating, verifying, and the like via a hardware element.

As used herein, the term “message” encompasses a wide variety of formats for communicating (e.g., transmitting or receiving) information. A message may include a machine readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

As user herein, the terms “correspond” or “corresponding” encompasses a structural, functional, quantitative and/or qualitative correlation or relationship between two or more objects, data sets, information and/or the like, preferably where the correspondence or relationship may be used to translate one or more of the two or more objects, data sets, information and/or the like so to appear to be the same or equal. Correspondence may be assessed using one or more of a threshold, a value range, fuzzy logic, pattern matching, a machine learning assessment model, or combinations thereof.

In some implementations, data generated or detected can be forwarded to a “remote” device or location, where “remote,” means a location or device other than the location or device at which the program is executed. For example, a remote location could be another location (e.g., office, lab, etc.) in the same city, another location in a different city, another location in a different state, another location in a different country, etc. As such, when one item is indicated as being “remote” from another, what is meant is that the two items can be in the same room but separated, or at least in different rooms or different buildings, and can be at least one mile, ten miles, or at least one hundred miles apart. “Communicating” information references transmitting the data representing that information as electrical signals over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data. Examples of communicating media include radio or infra-red transmission channels as well as a network connection to another computer or networked device, and the internet or including email transmissions and information recorded on websites and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

1. A sensor assembly for a receptacle, the sensor assembly comprising:
a bar having an adjustable feature that adjusts in response to a change in a fill level of the receptacle;
one or more sensors configured to detect the adjustable feature of the bar; and
a controller configured to determine, based at least on the adjustable feature of the bar, the fill level of the receptacle.

2. The sensor assembly of claim 1, wherein a proximate edge of the bar is secured by a pivoting joint that enables the bar to rotate in response to the change in the fill level of the receptacle.

3. The sensor assembly of claim 1, wherein a distal edge of the bar is configured to interact with a first sensor of the one or more sensors when the bar is at a first adjustable feature value corresponding to the receptacle being at a first fill level, and wherein the distal edge of the bar is further configured to interact with a second sensor of the one or more sensors when the bar is at a second adjustable feature value corresponding to the receptacle being at a second fill level.

4. The sensor assembly of claim 3, wherein the controller determines that the bar is at the first adjustable feature value based on a first signal generated by the first sensor in response to interacting with the bar at the first adjustable feature value, and wherein the controller determines that the bar is at the second adjustable feature value based on a second signal generated by the first sensor and the second sensor in response to interacting with the bar at the second adjustable feature value.

5. The sensor assembly of claim 3, wherein the controller determines that the bar is at a third adjustable feature value based on a third signal generated by the first sensor and the second sensor.

6. The sensor assembly of claim 3, wherein the adjustable feature comprises a length, an angle, and/or a position of the bar relative to the one or more sensors.

7. The sensor assembly of claim 6, wherein the controller determines that the bar is at a first length based on a signal from the one or more sensors indicating that the bar is at a first angle relative to the one or more sensors, and wherein the controller determines that the bar is at a second length based on the signal from the one or more sensors indicating that the bar is at a second angle relative to the one or more sensors.

8. The sensor assembly of claim 1, wherein the receptacle comprises a fileted edge configured to guide a distal edge of the bar through a transition between two orthogonal surfaces of the receptacle.

9. The sensor assembly of claim 1, wherein the bar comprises a telescoping bar, a spring, and/or a telescopic spring.

10. The sensor assembly of claim 1, wherein the one or more sensors comprise a sensory array disposed along an inner surface of the receptacle.

11. The sensor assembly of claim 1, wherein the one or more sensors are attached to the bar.

12. The sensor assembly of claim 1, wherein the one or more sensors comprise at least one of a gyroscope, a pressure sensor, a camera, a magnetic sensor, a radio frequency sensor, and a light sensor.

13. The sensor assembly of claim Lany wherein the controller is further configured to generate an indicator of the fill level of the receptacle and/or
the controller is physically coupled to the receptacle or is at a remote location.

14. The sensor assembly of claim 1, wherein the receptacle is configured to receive solid materials.

15. The sensor assembly of claim 1, wherein the receptacle comprises an entry mechanism for depositing items into the receptacle.

16. The sensor assembly of claim 15, wherein the controller is configured to respond to the fill level of the receptacle satisfying one or more thresholds by at least blocking the entry mechanism to prevent additional items from being deposited into the receptacle.

17. The sensor assembly of claim 15, wherein the entry mechanism comprises one or more of a slot, a slanted ramp, and a door.

18. The sensor assembly of claim 1, wherein the bar is configured to adjust from a first adjustable feature value to a second adjustable feature value in response to one or more items being deposited in the receptacle, and wherein the bar is further configured to reset back to the first adjustable feature value when the one or more items are removed from the receptacle.

19. The sensor assembly of claim 1, wherein the receptacle comprises a settling mechanism for optimizing an arrangement of items deposited into the receptacle.

20. The sensor assembly of claim 19, wherein the settling mechanism comprises one or more of a haptic signal and a pressure force.

21. (canceled)

22. (canceled)

23. (canceled)
